(19) United States
(12) Patent Application Publication
(10) Pub. No.: US 2011/0087494 A1
(43) Pub. Date: Apr. 14, 2011

(54) Apparatus and method of encoding audio signal by switching frequency domain transformation scheme and time domain transformation scheme

(75) Inventors: Jung Hoe Kim, Seongnam (KR); Eun Mi OH, Seongnam (KR); Ho Sang Sung, Yongin (KR); Ki Hyun Choo, Seoul (KR)

(73) Assignee: SAMSUNG ELECTRONICS CO., LTD., Suwon-si (KR)

(21) Appl. No.: 12/588,297

(22) Filed: Oct. 9, 2009

(51) Int. Cl. G10L 19/00

(52) U.S. Cl. 704/500

(57) ABSTRACT

Provided are an apparatus of encoding an audio signal by switching a time domain transformation scheme and a frequency domain transformation scheme, and an apparatus of decoding an audio signal by switching the time domain transformation scheme and the frequency domain transformation scheme. When any one transformation scheme of the time domain transformation scheme and the frequency domain transformation is switched into the other transformation scheme, an audio signal before and after the switching is encoded using an additionally transformed audio signal, or an encoded audio signal is decoded.

### BACKGROUND

1. Field

Exemplary embodiments relate to an apparatus and method of encoding an audio signal by switching a frequency domain transformation scheme and a time domain transformation scheme with each other.

2. Description of the Related Art

An existing sound/music compression method may be mainly classified into a time domain transformation scheme and a frequency domain transformation scheme. The frequency domain transformation scheme may be an algorithm of compressing signals in a frequency domain, and adopt a psychological sound model, thereby having a superior compression performance with respect to a music signal while having a poor compression performance with respect to a sound signal.

The time domain transformation scheme may be an algorithm of compressing signals in a time domain, and adopt a voice production model, thereby having a superior compression performance with respect to the sound signal while having a poor compression performance with respect to the music signal.

Thus, by using the above described characteristics, studies for schemes of effectively performing a compression with respect to audio signals including sound and music signals have been made.

According to the related arts, it may be determined which of the frequency domain transformation and the time domain transformation is performed with respect to the audio signals is more effective, and either the frequency domain transformation or the time domain transformation may be performed based on the determined result.

According to the related arts, when switching from the frequency domain transformation to the time domain transformation while performing the frequency domain transformation with respect to the audio signal, or when switching from the time domain transformation to the frequency domain transformation while performing the time domain transformation with respect to the audio signal, a restoration to an original signal may be impossible due to characteristics of a switching scheme used in a frequency domain coding, resulting in generation of a switching noise.

Accordingly, there is a desire for a transformation scheme of effectively performing a compression and an encoding with respect to an audio signal while preventing switching noise from being generated, even when switching from any one transformation scheme to the other transformation scheme while performing any one of a frequency domain transformation scheme and a time domain transformation scheme.

### SUMMARY

According to an aspect of exemplary embodiments, there is provided an audio signal encoding apparatus, including: a first transformation unit to perform any one transformation of a time domain transformation and a frequency domain transformation with respect to a first audio signal of a first time interval to generate a first transformation signal; a second transformation unit to perform the other transformation with respect to a second audio signal of a second time interval subsequent to the first time interval, the second time interval being adjacent to the first time interval, to generate a second transformation signal, the other transformation being different from the transformation performed by the first transformation unit; and a third transformation unit to perform any one transformation of the time domain transformation and the frequency domain transformation with respect to either the first audio signal or the second audio signal based on respective transformations of the first transformation unit and the second transformation unit to generate a third transformation signal. In this instance, the first audio signal may be reconstructed based on the first transformation signal and the third transformation signal, or the second audio signal may be reconstructed based on the second transformation signal and the third transformation signal.

According to another aspect of exemplary embodiments, there is provided an audio signal decoding apparatus, including: a first inverse transformation unit to perform any one inverse transformation of a time domain inverse transformation and a frequency domain inverse transformation with respect to a first transformation signal of a first time interval on which a time domain transformation or a frequency domain transformation is performed; a second inverse transformation unit to perform the other inverse transformation with respect to a second transformation signal of a second time interval subsequent to the first time interval, the second time interval being adjacent to the first time interval, to generate a second inverse transformation signal, the other inverse transformation being different from the inverse transformation performed by the first inverse transformation; a third inverse transformation unit to perform any one of the time domain inverse transformation and the frequency domain inverse transformation, with respect to either the first transformation signal or the second transformation signal based on respective inverse transformation schemes of the first inverse transformation unit and the second inverse transformation unit, to generate a third inverse transformation signal; and a signal restoration unit to reconstruct an audio signal of the first time interval based on the first inverse transformation signal and the third inverse transformation signal, or to reconstruct an audio signal of the second time interval based on the second inverse transformation signal and the third inverse transformation signal.

According to an aspect, there may be provided an apparatus and method of encoding an audio signal by switching a frequency domain transformation scheme and a time domain transformation scheme.

According to another aspect, there may be provided an apparatus and method of encoding an audio signal by switching a frequency domain transformation scheme and a time domain transformation scheme, thereby minimizing an amount of additionally encoded data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects will become apparent and more readily appreciated from the following description of exemplary embodiments, taken in conjunction with the accompanying drawings of which:

FIG. 1A and FIG. 1B are conceptual diagrams used for describing a Modulated Lapped Transformation (MLT) scheme used by an audio signal encoder and an audio signal decoder according to exemplary embodiments;

FIG. 2 illustrates an exemplary example of additionally encoding an audio signal after switching of a transformation scheme based on a signal before the switching, when a frequency domain transformation scheme is switched into a time domain transformation scheme;

FIG. 3 illustrates an exemplary example of performing a frequency domain transformation with respect to an audio signal before and after switching of a transformation scheme when a frequency domain transformation scheme is switched into a time domain transformation scheme;

FIG. 4 illustrates an exemplary embodiment of performing a time domain transformation with respect to an audio signal after a switching of a transformation scheme when a time domain transformation scheme is switched into a frequency domain transformation scheme;

FIG. 5 illustrates an exemplary embodiment of determining a length of a time domain before switching of a transformation scheme to be less than that of the time domain after the switching when a frequency domain transformation scheme is switched into a time domain transformation scheme;

FIG. 6 illustrates an exemplary embodiment of dividing audio signals before a switching of a transformation scheme and performing a transformation on each of the divided audio signals when a frequency domain transformation scheme is switched into a time domain transformation scheme;

FIG. 7 is a block diagram illustrating a structure of an encoder for performing either a time domain transformation scheme or a frequency domain transformation scheme by switching the time domain transformation scheme and the frequency domain transformation scheme with each other;

FIG. 8 is a block diagram illustrating a structure of a decoder for decoding an audio signal encoded by switching a time domain transformation scheme and a frequency domain transformation scheme with each other according to exemplary embodiments;

FIG. 9 is a flowchart illustrating a method of encoding an audio signal by switching a time domain transformation scheme and a frequency domain transformation scheme with each other according to exemplary embodiments;

FIG. 10 is a flowchart illustrating a method of decoding an audio signal encoded by switching a time domain transformation scheme and a frequency domain transformation scheme with each other according to exemplary embodiments;

FIG. 11 is a block diagram illustrating a structure of an audio signal encoder according to exemplary embodiments;

FIG. 12 is a flowchart illustrating an exemplary example of performing either a frequency domain inverse transformation or a time domain inverse transformation with respect to an input signal according to exemplary embodiments;

FIG. 13 is a flowchart illustrating another exemplary embodiment of performing either a frequency domain inverse transformation or a time domain inverse transformation with respect to an input signal according to exemplary embodiments;

FIG. 14 is a flowchart illustrating an exemplary embodiment of performing either a frequency domain transformation or a time domain transformation with respect to an input signal according to exemplary embodiments; and

FIG. 15 is a flowchart illustrating another exemplary embodiment of performing either a frequency domain transformation or a time domain transformation with respect to an input signal according to exemplary embodiments.

FIG. 16 is a block diagram illustrating an exemplary embodiment applied in a Moving Picture Experts Group (MPEG) Unified Speech and Audio Coding (USAC).

FIG. 17 illustrates an exemplary embodiment of interleaving additionally encoded data and current frame data.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

Respective audio signals encoded in various exemplary embodiments of the present disclosure may be audio signals transmitted from an identical audio source, and may be divided according to respective time intervals. That is, a first audio signal and a second audio signal may be an audio signal respectively corresponding to a first time interval and a second time interval in a specific audio source. Also, a first transformation signal and a second transformation signal may be signals on which a time domain transformation or a frequency domain frequency is performed with respect to the first audio signal and the second audio signal, and may correspond to the first time interval and the second time interval.

Hereinafter, exemplary embodiments of the present disclosure will be described in detail with reference to drawings.

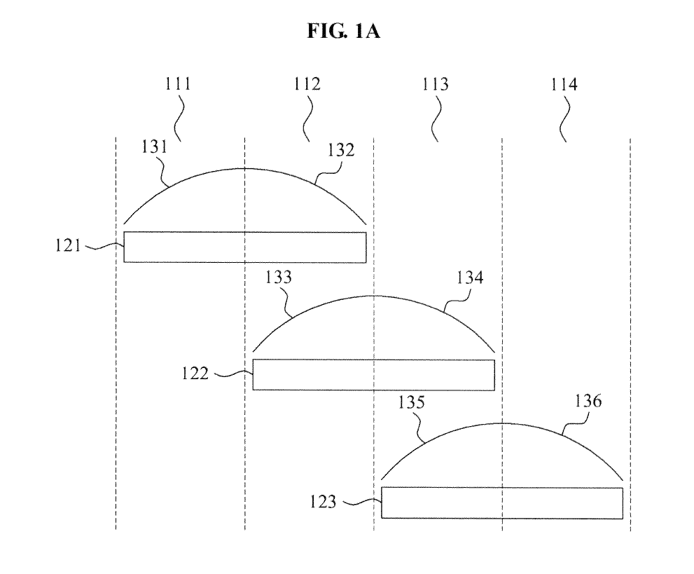

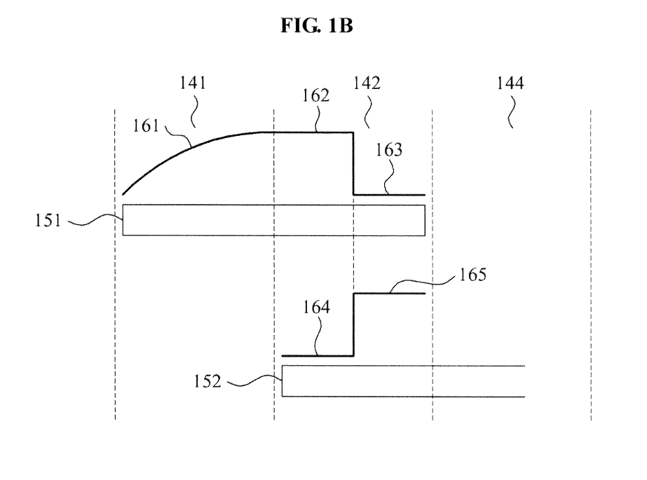

FIG. 1A and FIG. 1B are conceptual diagrams used for describing a Modulated Lapped Transformation (MLT) scheme used by an audio signal encoder and an audio signal decoder according to exemplary embodiments. The MLT scheme will be herein described in detail with reference to FIG. 1.

In order to perform a frequency domain transformation with respect to an audio signal, a certain time interval may be designated using a basic unit of a transformation, and the frequency domain transformation with respect to the audio signal within a predetermined time interval may be performed. In this instance, when the predetermined time interval is not overlapped, a discrete signal between respective blocks may be generated due to quantization in encoding/decoding. This may be referred to a blocking artifact in a case of video compression, and the blocking artifact may be a significant deterioration in the audio signal.

Accordingly, for an audio signal compression, the MLT scheme in which respective time intervals are set to be overlapped with each other may be used.

In the MLT scheme, a transformed signal may be reconstructed using an overlap between neighboring frames, so that the discrete signal is not generated, and a signal identical to an original signal may be reconstructed when using an appropriately designed window. For example, in a Modified Discrete Cosine Transformation (MDCT) generally used in audio signal compression, a frame may be overlapped by ½ of a length of the frame and transformed using a sine time window, and thereby a signal identical to the original signal may be generated through a transformation and an inverse transformation.

FIG. 1A illustrates an example of performing a frequency domain transformation with respect to audio signals of two time intervals being adjacent to each other. Audio signals 121, 122, and 123 of the two time intervals may be transformed during respective time interval 111, 112, 113, and 114. That is, during a specific time interval 112, a frequency domain transformation may be performed with respect to audio signals of the specific time interval 112 and a preceding time interval 111 during the specific time interval 112.

Respective curved lines illustrated in FIG. 1A may designate each window coefficient. For a perfect reconstruction of the MDCT, Equation 1 below may be satisfied. In Equation 1, x denotes an input signal, X denotes a transformed frequency element, and y denotes an inverse-transformed signal using an inverse MDCT. A first inverse transformation signal inverse-transformed in an N-th time interval and a second inverse transformation signal inverse-transformed in the preceding N-th time interval may be overlapped during a predetermined time interval. An original signal may be reconstructed when adding the two inverse transformation signals to the time interval when the first inverse transformation signal and the second inverse transformation signal are overlapped. Also, in Equation 1, 2M denotes a length of the transformation.

$$X ( k ) = \sqrt{\frac{2}{M}} {\sum }_{n = 0}^{2 M - 1} x ( n ) h ( n ) cos [ ( n + \frac{M + 1}{2} ) ( k + \frac{1}{2} ) \frac{π}{M} ] \\ y ( n ) = \sqrt{\frac{2}{M}} {\sum }_{k = 0}^{M - 1} X ( k ) h ( n ) cos [ ( n + \frac{M + 1}{2} ) ( k + \frac{1}{2} ) \frac{π}{M} ] , \qquad [ Equation 1 ]$$

where h denotes a curved line of 131 to 136, and may satisfy Equation 2 below to thereby achieve a perfect reconstruction.

h(n)=h(2M−1−n)

h²(n)+h²(n+M)=1′ [Equation 2]

where h may be right and left symmetrical with a window of an overlapped part of the preceding frame, and a sum of squares of respective window coefficients may be ‘1’. The curved lines 132 and 133 may be symmetrical with each other. In FIG. 1B, lines 162 and 163 may be symmetrical with each other, and a sum of squares of the respective window coefficients may be ‘1’, and thus the perfect reconstruction may be achieved through a corresponding window coefficient. In FIG. 1B, an overlap may be shown in a time interval 142, however, an overlap effect may not be obtained due to a window coefficient of a time interval 163 being zero, thereby reducing a ratio of over-coding. In order to perfectly reconstruct a signal, aliasing elements included in the overlapped part may need to be mutually removed due to characteristics of the above described transformation scheme.

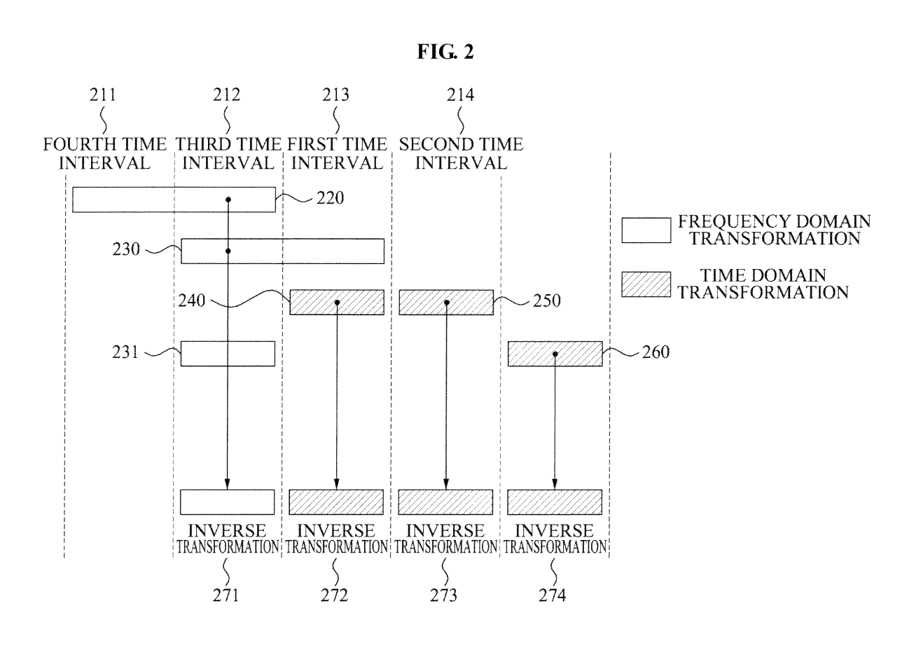

FIG. 2 illustrates an exemplary example of additionally encoding an audio signal after switching of a transformation scheme based on a signal before the switching, when a frequency domain transformation scheme is switched into a time domain transformation scheme. The exemplary example of additionally encoding the audio signal after the transformation scheme will be herein described in detail with reference to FIG. 2.

Referring to FIG. 2, a frequency domain transformation may be performed in a fourth time interval 211, a third time interval 212, and a first time interval 213, and a time domain transformation may be performed in a second time interval 214.

A frequency domain transformation 220 may be performed with respect to an audio signal of the third time interval 212 together with an audio signal of the fourth time interval 211, and a frequency domain transformation 230 may be performed with respect to the audio signal of the third time interval 212 together with an audio signal of the first time interval 213. The audio signal of the third time interval 212 where the frequency domain transformation is performed twice may be reconstructed by adding each of audio signals to which an inverse transformation 271 is performed.

The frequency domain transformation 230 may be performed with respect to the audio signal of the first time interval 213 and the audio signal of the third time interval 212. The audio signal of the first time interval 213 may be inverse-transformed into a time domain signal, however, since one signal is inverse-transformed, the time domain signal may not be reconstructed

A time domain transformation 250 may be performed with respect to an audio signal of the second time interval 214. The time domain transformed signal may be separately reconstructed regardless of an audio signal of a neighboring time interval 214.

According to an exemplary embodiment, to reconstruct the audio signal of the first time interval 213 where the frequency domain transformation is performed, the audio signal of the first time interval 213 may be additionally transformed.

According to an exemplary embodiment, a time domain transformation 240 may be performed with respect to the audio signal of the first time interval 213. In a time interval 272, the audio signal of the first time interval 213 may be reconstructed based on the audio signals to which the time domain transformation 240 is performed.

According to an exemplary embodiment, the audio signal of the first time interval 213 may be effectively transformed with reference to a reference signal 231 of the third time interval 212 prior to the first time interval 213.

The audio signal encoder according to an exemplary embodiment may perform a frequency domain transformation with respect to a third audio signal of the third time interval and a fourth audio signal of the fourth time interval to generate a fourth transformation signal. Also, a frequency domain transformation may be performed with respect to a first audio signal of the first time interval and the third audio signal of the third time interval to generate a third audio signal.

The audio signal decoder according to an exemplary embodiment may reconstruct the third audio signal of the third time interval using the fourth transformation signal and the first transformation signal. Also, the audio signal decoder may reconstruct the first audio signal of the first time interval base on the third audio signal of the third time interval.

The audio signal encoder according to an exemplary embodiment may generate a predictive signal with respect to the first audio signal based on the third audio signal. The audio signal encoder according to an exemplary embodiment may performed a time domain coding with respect to only a difference between the predictive signal and the first audio signal. Since the first audio signal may be encoded based on information about the preceding time interval, the first audio signal may be more effectively encoded.

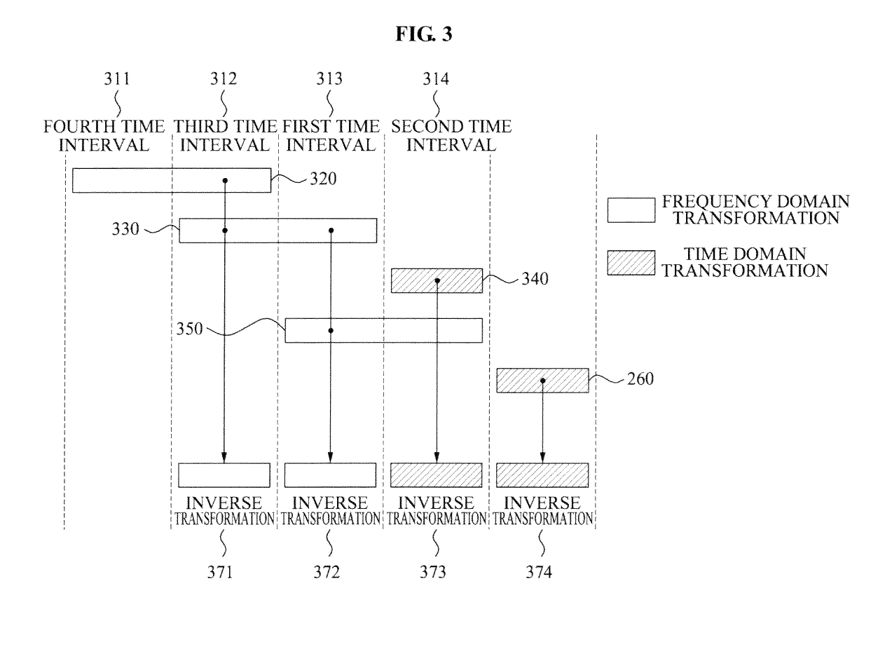

FIG. 3 illustrates an exemplary example of performing a frequency domain transformation with respect to an audio signal before and after switching of a transformation scheme when a frequency domain transformation scheme is switched into a time domain transformation scheme. The exemplary embodiment of performing the frequency domain transformation with respect to the audio signal before and after switching will be herein described in detail with reference to FIG. 3.

Referring to FIG. 3, a frequency domain transformation may be performed in a fourth time interval 311, a third time interval 312, and a first time interval 313, and a time domain transformation may be performed in a second time interval 314.

An audio signal encoder according to an exemplary embodiment may perform a frequency domain transformation with respect to a third audio signal of the third time interval 312 together with a fourth audio signal of the fourth time interval. Accordingly, the audio signal encoder may reconstruct the third audio signal of the third time interval 312.

The audio signal encoder according to an exemplary embodiment may perform a time domain transformation with respect to the second audio signal of the second time interval. Since the audio signal to which the time domain transformation is performed may be separately reconstructed regardless of audio signals of different time intervals, an audio signal decoder according to an exemplary embodiment may reconstruct the second audio signal of the second time interval.

The audio signal encoder according to an exemplary embodiment may additionally perform the frequency domain transformation with respect to the first audio signal of the first time interval 313 together with the second audio signal of the second time interval 314. Since the first audio signal of the first time interval 313 may be frequency domain-encoded twice, the audio signal decoder may reconstruct the first audio signal of the first time interval 313.

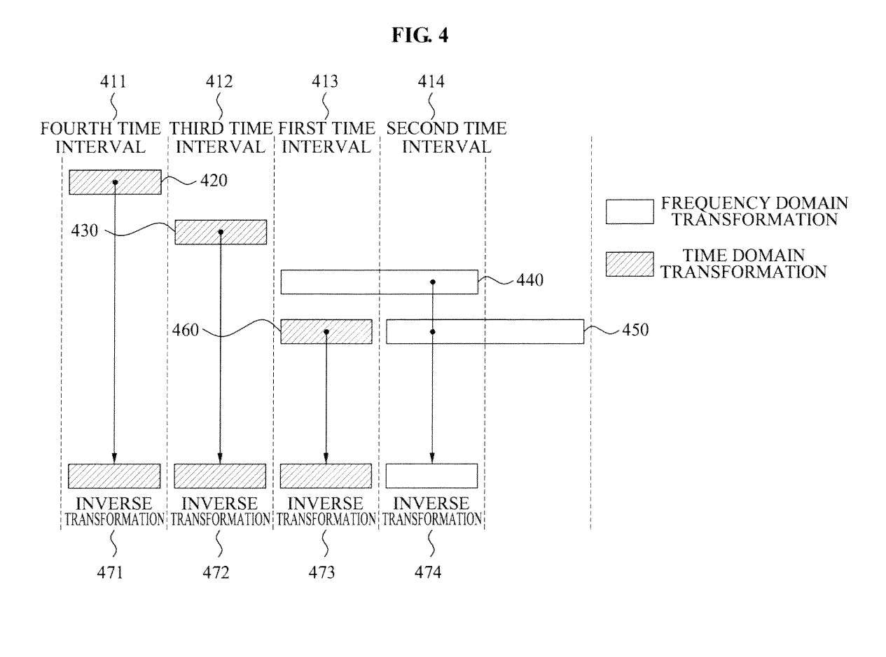

FIG. 4 illustrates an exemplary embodiment of performing a time domain transformation with respect to an audio signal after a switching of a transformation scheme when a time domain transformation scheme is switched into a frequency domain transformation scheme. The exemplary embodiment of performing the time domain transformation with respect to the audio signal after the switching will be herein described in detail with reference to FIG. 2.

Referring to FIG. 2, a time domain transformation may be performed in a fourth time interval 411 and a first time interval 412, and a frequency domain transformation may be performed in a second time interval 413 and a third time interval 414.

An audio signal encoder according to an exemplary embodiment may perform a time domain coding with respect to the fourth audio signal of the fourth time interval 411 and the first audio signal of the first time interval 412. The audio signal to which the time domain coding is performed may be separately reconstructed regardless of audio signals of different time intervals. Accordingly, an audio signal decoder according to an exemplary embodiment may reconstruct the audio signals of the fourth time interval 411 and the first time interval 412.

The audio signal encoder according to an exemplary embodiment may perform a frequency domain coding with respect to the second audio signal of the second time interval 413 together with the third audio signal of the third time interval 414. Since the audio signal encoder according to an exemplary embodiment again performs the frequency domain transformation with respect to the third audio signal of the third time interval 414 together with an audio signal subsequent to the third time interval 414, the third audio signal of the third time interval 414 may be consequently encoded twice. Accordingly, the audio signal encoder according to an exemplary embodiment may reconstruct the third audio signal.

However, since the second audio signal of the second time interval 413 is encoded once, the audio signal encoder according to an exemplary embodiment may not reconstruct the second audio signal although performing a frequency domain transformation with respect to the second audio signal of the second time interval 413.

The audio signal encoder according to an exemplary embodiment may additionally perform the time domain transformation with respect to the second audio signal of the second time interval 413. When the second audio signal is time domain coded, the audio signal decoder according to an exemplary embodiment may reconstruct the second audio signal of the second time interval 413.

The audio signal encoder according to an exemplary embodiment may generate a predictive signal with respect to the second audio signal based on the first audio signal of the first time interval 412, and may perform a time domain coding with respect to a difference between the second audio signal and the predictive signal with respect to the second audio signal. The second audio signal may be reconstructed only when the first audio signal is reconstructed, however, the second audio signal may be more effectively encoded.

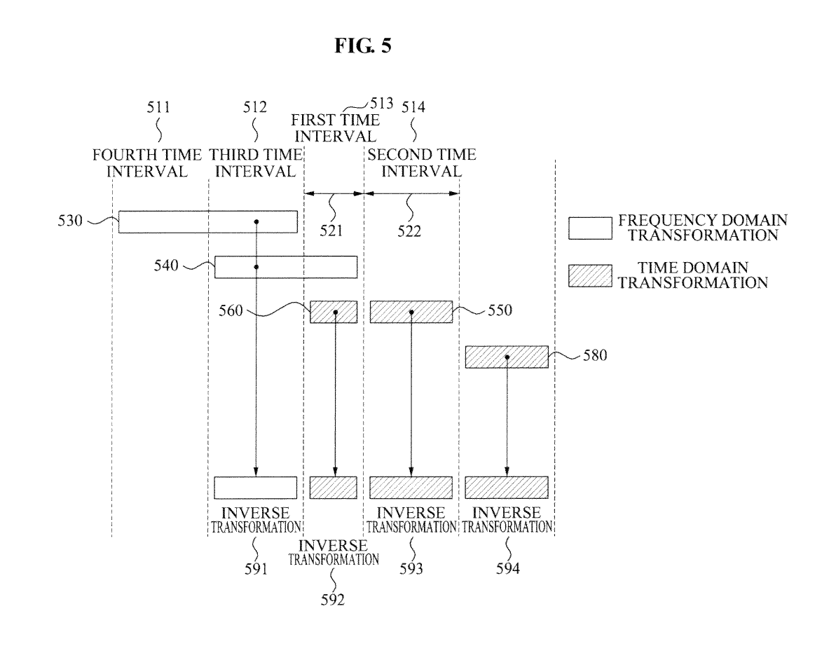

FIG. 5 illustrates an exemplary embodiment of determining a length of a time domain before switching of a transformation scheme to be less than that of the time domain after the switching when a frequency domain transformation scheme is switched into a time domain transformation scheme. The exemplary embodiment of determining the length of the time domain before switching of the transformation scheme to be less than that of the time domain after the switching will be herein described in detail with reference to FIG. 5.

Referring to FIG. 5, similar to the description given above with reference to FIG. 2, a frequency domain transformation may be performed in a fourth time interval 511, a third time interval 512, and a first time interval 513, and a time domain transformation may be performed in a second time interval 514.

In order to reconstruct a first audio signal of the first time interval 513 to which the frequency domain transformation is performed once, an audio signal encoder according to an exemplary embodiment may additionally perform the time domain transformation.

The audio signal encoder according to an exemplary embodiment may determine a time length 521 of the first time interval 513 to be less than a time length 522 of the second time interval 514 or a time length of the third time interval 512.

When the time length 521 of the first time interval 513 is less, an amount of an audio signal 560 to which the time domain transformation is additionally performed may be reduced. Since the time domain transformation is performed with respect to only a smaller amount of an audio signal, an encoding efficiency of the audio signal encoder may be improved.

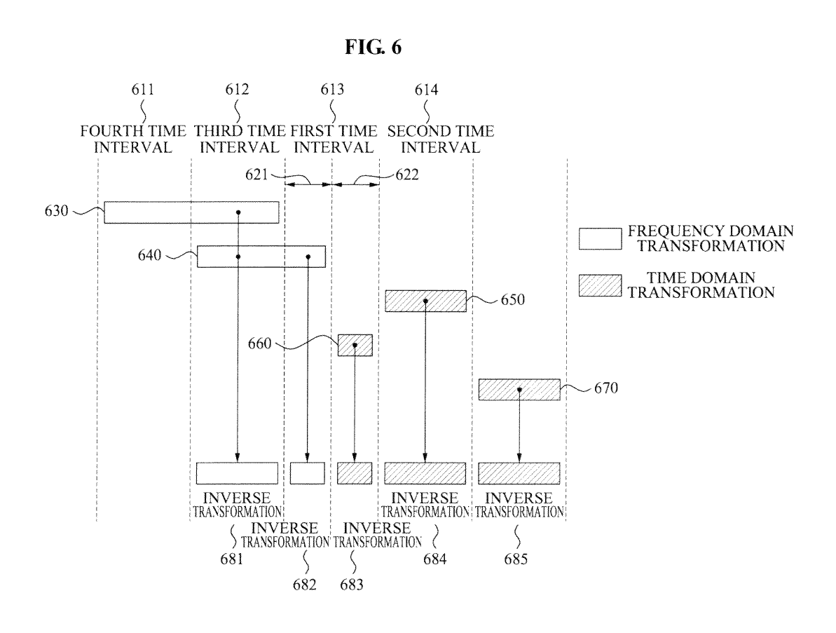

FIG. 6 illustrates an exemplary embodiment of dividing audio signals before a switching of a transformation scheme and performing a transformation on each of the divided audio signals when a frequency domain transformation scheme is switched into a time domain transformation scheme. The exemplary embodiment of dividing audio signals before the switching and performing the transformation on each of the divided audio signals will be herein described in detail with reference to FIG. 6.

Referring to FIG. 6, a frequency domain transformation may be performed with respect to audio signals of a fourth time interval 611, a third time interval 612, and a first time interval 613, and a time domain transformation may be performed the first time interval 613 and a second time interval 614.

An audio signal encoder according to an exemplary embodiment may perform, once, the frequency domain transformation with respect to a third audio signal of the third time interval 612 together with a fourth audio signal of the fourth time interval 611, and perform, once more, the frequency domain transformation with respect the third audio signal together with a first audio signal of the first time interval 613. Accordingly, the audio signal encoder according to an exemplary embodiment may reconstruct the third audio signal of the third time interval 612.

The audio signal encoder according to an exemplary embodiment may divide the first time interval 613 into a fist time domain 621 and a second time domain 622. The audio signal encoder may perform a frequency domain coding with respect to a first audio signal of the first time domain 621 together with third audio signal of the third time interval. The audio signal encoder may perform the time domain transformation with respect to the first audio signal of the second time domain 622.

The audio signal encoder may reconstruct the first audio signal of the second time domain 622 of the time domain transformed second time domain 622.

Referring to FIG. 1B, the audio signal encoder may divide a first time domain and a second time domain using a rectangular time window. A sine time window 141 used in the fourth time interval 611 and the third time interval 612 may have a coefficient not less than zero over all specific time intervals, however, the rectangular time windows 162, 163, 164, and 165 used in the first time interval may have a coefficient not less than zero in the specific time domains 162 and 165 of the specific time interval 142, however, have a gain of zero in another time domains 163 and 164.

As for the audio signal encoder, the sine time window 141 and the rectangular time windows 162, 163, 164, and 165 may be designed by limitations of the window coefficient for satisfying the perfect reconstruction of the MDCT

When the audio signal encoder uses the rectangular time window, the frequency domain transformation may be performed with respect to only half of an entire element of the first audio signal of the first time interval 613, and thus a change in hardware may be minimized to perform the frequency domain transformation, similar to the frequency domain transformation with respect to the third audio signal of the third time interval 612.

As illustrated in FIG. 6, the audio signal may be encoded without additionally performing a transformation with respect to the audio signal.

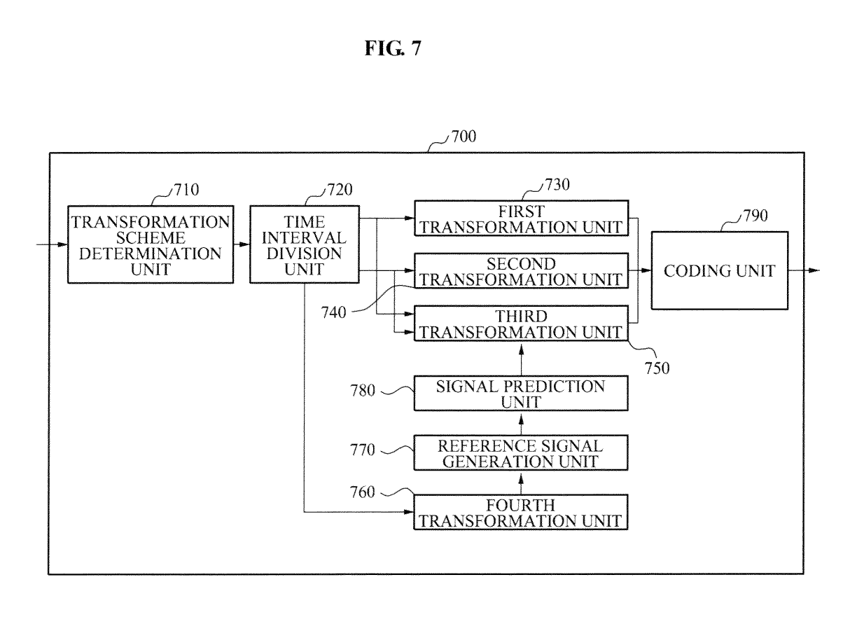

FIG. 7 is a block diagram illustrating a structure of an encoder 700 for performing either a time domain transformation scheme or a frequency domain transformation scheme by switching the time domain transformation scheme and the frequency domain transformation scheme with each other.

An operation of the encoder 700 according to an exemplary embodiment will be herein described in detail with reference to FIG. 7. The encoder 700 includes a transformation scheme determination unit 710, a time interval division unit 720, a first transformation unit 730, a second transformation unit 740, a third transformation unit 750, a fourth transformation unit 760, a reference signal generation unit 770, and a signal prediction unit 780.

According to an exemplary embodiment, the respective transformation units 730, 740, and 750 may perform a frequency domain transformation using the MLT scheme. The MLT scheme is described in FIG. 1, and thus a detailed description thereof will be herein omitted.

The first transformation unit 730 may perform a time domain inverse transformation with respect to the first transformation signal of the first time interval to which the time domain transformation or the frequency domain transformation having been performed, or perform a frequency domain inverse transformation with respect to the first audio signal of the first time interval and the third audio signal of the third time interval to thereby generate a first inverse transformation signal.

The second transformation unit 740 may perform an inverse transformation, being different from the inverse transformation performed by the first transformation unit 730 from among the time domain inverse transformation and the frequency domain inverse transformation, with respect to the second audio signal of the second time interval being adjacent to the first time interval and subsequent to the first time interval, thereby generating second inverse transformation signal. When the frequency domain inverse transformation is performed in the second transformation unit 740, the first audio signal of the first time interval and the second audio signal of the second time interval may be used to perform the frequency domain inverse transformation.

When the transformation performed by the first transformation unit 730 is different from that performed by the second transformation unit 740, only insufficient information for reconstructing the audio signal to which the transformation is performed by the first transformation unit 730 or the second transformation unit 740 may be transformed. That is, an original signal may not be reconstructed using only the audio signal to which the transformation is performed by the respective transformation units 730 and 740.

The audio signal encoder 700 according to an exemplary embodiment may additionally perform a transformation with respect to the audio signal to which the transformation is performed by the first transformation unit 730 or the second transformation unit 740. An audio signal decoder 800 according to an exemplary embodiment may accurately reconstruct the audio signal to which the transformation is performed by the first transformation unit 730 or the second transformation unit 740 based on the audio signal to which the transformation is additionally performed.

The third transformation unit 750 may perform any one transformation of the frequency domain transformation and the time domain transformation with respect to the second audio signal or the first audio signal based on the transformations performed by the first transformation unit 730 and the second transformation unit 740 to thereby generate a third transformation signal. The third transformation unit 750 may perform the transformation with respect to the first audio signal or the second audio signal depending on whether the frequency domain transformation or the time domain transformation is performed with respect to the first audio signal. Also, the third transformation unit 750 may perform the frequency domain transformation or the time domain transformation depending on whether the frequency domain transformation or the time domain transformation is performed with respect to the first audio signal. Various examples of additionally perform the transformation with respect to the first audio signal or the second audio signal are described in detain in FIGS. 2 to 6.

When the third transformation unit 750 additionally performs the transformation with respect to the first audio signal, the first audio signal may be reconstructed based on the first transformation signal obtained by the first transformation unit 730 and the third transformation signal obtained by the third transformation unit 750.

When the third transformation unit 750 additionally performs the transformation with respect to the second audio signal, the second audio signal may be reconstructed based on the second transformation signal obtained by the second transformation unit 740 and the third transformation signal obtained by the third transformation unit 750.

The transformation scheme determination unit 710 may determine transformation schemes performed by the first transformation unit 730, the second transformation unit 740, and the third transformation unit 750, with respect to the first audio signal of the first time interval and the second audio signal of the second time interval.

The transformation scheme determination unit 710 may determine the respective transformation units 730, 740, and 750 to perform the time domain transformation with respect to a voice signal such as a human voice, and also determine the respective transformation units 730, 740, and 750 to perform the frequency domain transformation with respect to a music sound and the like.

The first transformation unit 730 may perform the frequency domain transformation with respect to the first audio signal and the third audio signal of the third time interval prior to the first time interval. In this instance, the third time interval is adjacent to the first time interval. Also, the fourth transformation unit 760 may perform the frequency domain transformation with respect to the third audio signal and the fourth audio signal of the fourth time interval. The fourth time interval may be prior to the third time interval, and may be adjacent to the third time interval.

The audio signal encoder according to an exemplary embodiment may additionally perform the time domain coding with respect to the first audio signal based on the third audio signal. The fourth transformation unit 760 may perform the frequency domain transformation to generate a fourth transformation signal, and the reference signal generation unit 770 may generate a time domain reference signal based on the fourth transformation signal and the first transformation signal. The time domain reference signal may be a signal obtained by reconstructing the third audio signal of the third time interval based on the first transformation signal and the fourth transformation signal by the reference signal generation unit 770.

The signal prediction unit 780 may generate a predictive signal with respect to an audio signal of the first time interval based on the time domain reference signal. The signal prediction unit 780 may generate the predictive signal from the time domain reference signal using a liner prediction scheme or a long prediction scheme. When the time domain transformation is performed with respect to the audio signal of the first time interval based on the third audio signal, an encoding may be effectively performed since an amount of data after the transformation is reduced.

The third transformation unit 750 may perform the time domain transformation with respect to a difference between the first audio signal and the predictive signal to additionally perform a transformation with respect to the first audio signal.

The third transformation unit 750 may singly perform the time domain transformation with respect to the first audio signal without being based on the third audio signal of the third time interval. The third transformation unit 750 may perform the time domain transformation based on at least one of an Adaptive Differential Pulse Code Modulation (ADPCM) coding scheme, a Mu-Law coding scheme, and a A-law coding scheme. Since the first audio signal is time-domain transformed without being based on the third audio signal, the first audio signal may be simply transformed.

The audio signal encoder 700 may determine a length of a time interval including the additionally transformed audio signal to be less than a length of another time interval. That is, when the first audio signal of the first time interval is frequency-domain transformed and the second audio signal of the second time interval is time-domain transformed, the audio signal encoder may additionally perform the time domain transformation with respect to the first audio signal. In this case, the audio signal encoder may determine a length of the first time interval to be less than that of the second time interval. When the length of the time interval is less than that of the second time interval, the length of the additionally transformed first audio signal may be reduced, the audio signal may be transformed by performing fewer operations. When the transformed audio signal is transmitted through a communication network, the audio signal may be transmitted even using a relatively smaller bandwidth. Also, when the transformed audio signal is stored in a storage medium, a storage space may be minimized.

The time interval division unit 720 may divide the first time interval into a first time domain and a second time domain. The first transformation unit 730 may perform a transformation only with respect to the first audio signal of the first time interval excluding a first audio signal of the second time domain from among the first audio signals of the first time interval. Also, the third transformation unit 750 may perform the transformation only with respect to the first audio signal of the second time interval excluding the first audio signal of the first time domain from among the first audio signals of the first time interval. The transformation performed by the third transformation unit 750 may be different from the transformation performed by the first transformation unit 730.

It is assumed that the first transformation unit 730 may perform the frequency domain transformation with respect to an audio signal of the first time domain, and the third transformation unit 750 may perform the time domain transformation with respect to an audio signal of the second time domain. The audio signal of the first time domain may be transformed only once. The first transformation unit 730 may perform the transformation with respect to only a part of the first audio signal using the frequency domain transformation performed once. Accordingly, a general MLT scheme using the sine time window may not successfully reconstruct data.

The time interval division unit 720 may divide the audio signal of the first time domain and the audio signal of the second time domain using the rectangular time window. The first transformation unit 730 may perform the transformation with respect to all audio signals located in the first time domain from among the first audio signals when using the rectangular time window. The audio signal decoder according to an exemplary embodiment may reconstruct the audio signals located in the first time domain.

The third transformation unit 750 may perform the time domain transformation with respect to the audio signal included in the second time domain. According to the present exemplary embodiment, the audio signal may not be additionally transformed.

A coding unit 790 may perform an encoding with respect to the signals transformed in the respective transformation units 730, 740, and 750. According to an exemplary embodiment, the coding unit 790 may perform a frequency domain coding with respect to the frequency-domain transformed signal. According to an exemplary embodiment, the coding unit 790 may perform the frequency domain coding based on an advanced audio coding (AAC) scheme used in a Moving Picture Experts Group (MPEG).

The coding unit 790 may perform a time domain coding with respect to the time-domain transformed signal. The coding unit 790 may perform the time domain coding based on a code excited liner prediction (CELP)-based such as an Adaptive MultiRate (AMR), an Enhanced Variable Rate Codec (EVRC), and the like.

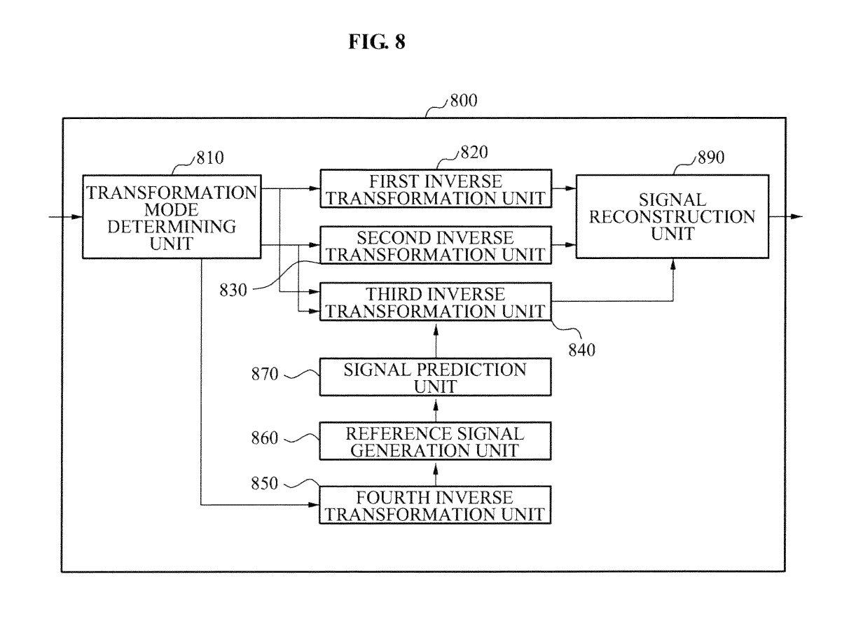

FIG. 8 is a block diagram illustrating a structure of a decoder 800 for decoding an audio signal encoded by switching a time domain transformation scheme and a frequency domain transformation scheme with each other according to exemplary embodiments. The decoder 800 according to an exemplary embodiment includes a transformation mode determining unit 810, a first inverse transformation unit 820, a second inverse transformation unit 830, a third inverse transformation unit 840, a fourth inverse transformation unit 850, a reference signal generation unit 860, a signal prediction unit 870, and a signal reconstruction unit 890.

The respective inverse transformation units 810, 820, and 830 may perform a frequency domain inverse transformation based on the MLT scheme. The MLT scheme is described with reference to FIG. 1, and thus a detailed description thereof will herein omitted.

The first inverse transformation unit 820 may perform any one of a time domain inverse transformation and a frequency domain inverse transformation with respect to the first transformation signal of the first time interval to which the time domain transformation or the frequency domain transformation having been performed to thereby generate a first inverse transformation signal.

The second inverse transformation unit 830 may perform the other inverse transformation with respect to the second transformation signal of the second time interval to thereby generate a second inverse transformation signal. In this instance, the inverse transformation performed by the second inverse transformation unit 830 may be different from that performed by the fist inverse transformation unit 820. Here, the second time interval may be adjacent to the first time interval, and may be a time interval subsequent to the first time interval.

When the inverse transformation performed by the first inverse transformation unit 820 and the inverse transformation performed by the second inverse transformation unit 830 are different from each other, sufficient information for reconstructing an audio signal before the transformation may not generated using only the inverse transformations performed by the first inverse transformation unit 820 and the second inverse transformation unit 830. In this case, the audio signal before the transformation may be reconstructed based on a result of the inverse transformation performed by the third inverse transformation unit 840.

The third inverse transformation unit 840 may perform the time domain inverse transformation or the frequency domain inverse transformation with respect to the first transformation signal or the second transformation signal to which the time domain transformation or the frequency domain transformation having been performed based on inverse transformation schemes used by the first inverse transformation unit 820 and the third inverse transformation unit 830. The third inverse transformation unit 840 may perform the time domain inverse transformation or the frequency domain inverse transformation to generate a third inverse transformation signal. The third inverse transformation unit 840 may perform the time domain inverse transformation or the frequency domain inverse transformation depending on whether the first transformation signal is frequency-domain transformed or time-domain transformed. Various examples of additionally performing an inverse transformation with respect to the first transformation signal or the second transformation signal were described in detail in FIGS. 2 to 6.

The signal reconstruction unit 890 may reconstruct the first audio signal based on the first inverse transformation signal and the third inverse transformation signal, or may reconstruct the second audio signal based on the second inverse transformation signal and the third inverse transformation signal.

The transformation mode determining unit 810 may determine whether the audio signal of the respective time intervals is time-domain transformed or frequency-domain transformed. The respective inverse transformation units 820, 830, 840, and 850 may perform the inverse transformation with respect to the respective transformation signals based on a determined result of the transformation mode determining unit 810.

The first inverse transformation unit 820 may perform the frequency domain inverse transformation with respect to the first transformation signal and the third transformation signal. Also, the fourth inverse transformation unit 850 may perform the frequency domain inverse transformation with respect to the third transformation signal and the fourth transformation signal. The fourth inverse transformation unit 850 may perform the frequency domain inverse transformation to generate a fourth inverse transformation signal.

The reference signal generation unit 860 may generate a time domain reference signal corresponding to the audio signal of the third time interval based on the fourth inverse transformation signal and the first inverse transformation signal.

The signal prediction unit 870 may generate a predictive signal with respect to the audio signal of the first time interval based on the time domain reference signal.

The signal reconstruction unit 860 may reconstruct the audio signal of the first time interval based on the time domain reference signal.

The signal reconstruction unit 860 may reconstruct the audio signal of the first time interval based on the third inverse transformation signal and the predictive signal. When the audio signal of the first time interval is time-domain transformed using the liner prediction scheme or the long term prediction scheme, the third inverse transformation generated by the third inverse transformation unit 840 may correspond to a different between the audio signal of the first time interval and the predictive signal. The signal reconstruction unit 860 may reconstruct the audio signal of the first time interval by adding the third inverse transformation signal and the predictive signal. When the audio signal is reconstructed based on the predictive signal, an amount of data before and after the transformation may be reduced, and thus the transformed signal may be advantageously transmitted through a communication network or stored in a storage medium.

According to an exemplary embodiment, a length of the time interval where the audio signal is additionally transformed may be less than a length of another time interval. Since the length of the additionally transformed audio signal is reduced, a less amount of an operation may be performed to thereby perform an inverse transformation with respect to the audio signal. Also, when the transformed audio signal is transmitted through the communication network, the transformed audio signal may be transmitted even using a relatively less bandwidth, and when the transformed audio signal is stored in the storage medium, a storage space may be minimized.

The audio signal decoder according to an exemplary embodiment may divide a time interval into a plurality of time domains, and perform different inverse transformations with respect to transformation signals corresponding to the respective time domains. For example, it is assumed that the first time interval is divided into a first time domain and a second time domain subsequent to the first time domain.

A first transformation signal of the first time domain from among the first transformation signals of the first time interval may be frequency-domain transformed, and the first inverse transformation unit 820 may perform the frequency domain inverse transformation with respect to the first transformation signal of the first time domain. Also, a first transformation signal of the second time domain from among the first transformation signals of the first time interval may be time-domain transformed, and the third inverse transformation unit 840 may perform the time domain inverse transformation with respect to the first transformation signal of the second time domain.

When the first transformation signal of the first time domain is a signal transformed using the rectangular time window described in FIG. 1B, the signal reconstruction unit 890 may reconstruct the audio signal of the first time domain only using the first inverse transformation signal. Also, the third inverse transformation unit 840 may perform an inverse transformation with respect to the audio signal of the second time domain to which the time domain transformation having been performed. The signal reconstruction unit 890 may reconstruct the audio signal of the second time domain based on the second transformation signal to which the time domain inverse transformation having been performed.

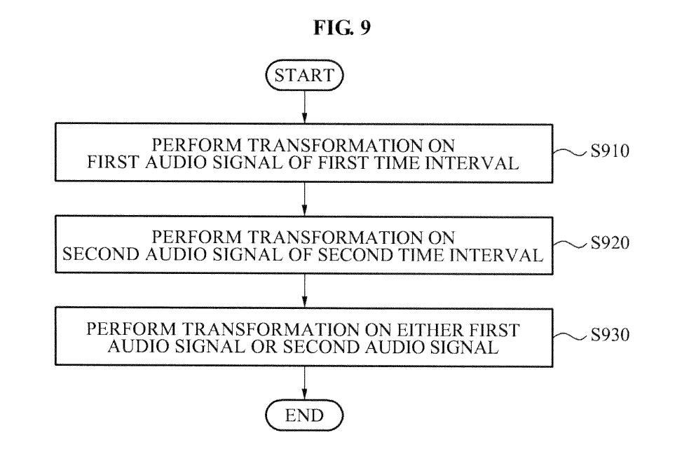

FIG. 9 is a flowchart illustrating a method of encoding an audio signal by switching a time domain transformation scheme and a frequency domain transformation scheme with each other according to exemplary embodiments. The method of encoding the audio signal according to an exemplary embodiment will be herein described in detail with reference to FIG. 9.

In operation S910, the method may perform any one of a time domain transformation and a frequency domain transformation with respect to a first audio signal of a first time interval to generate a first transformation signal.

In operation S920, the method may perform the other transformation with respect to a second audio signal of a second time interval. In this instance, the second time interval may be adjacent to the first time interval, and may be a time interval subsequent to the first time interval.

That is, in a boundary of the first time interval and the second time interval, a transformation scheme with respect to the audio signal may be switched.

In operation S930, the method may additionally perform the time domain transformation or the frequency domain transformation with respect to the first audio signal or the second audio signal based on the transformation schemes of operations S910 and S920, thereby generate a third transformation signal. A type and object of the transformation performed in operation S930 may be determined based on the transformation schemes of operations S910 and S920. Determining the type and object of the transformation performed in operation S930 based on various transformation schemes in operations S910 and S920 is described in detail in FIGS. 2 to 6, and thus a detailed description thereof will be herein omitted.

The first transformation signal and the second transformation signal transformed in operations S910 and S920 may be reconstructed based on the third transformation signal. The first audio signal of the first time interval may be reconstructed based on the first transformation signal and the third transformation signal. Also, the second audio signal may be reconstructed based on the second transformation signal and the third transformation signal.

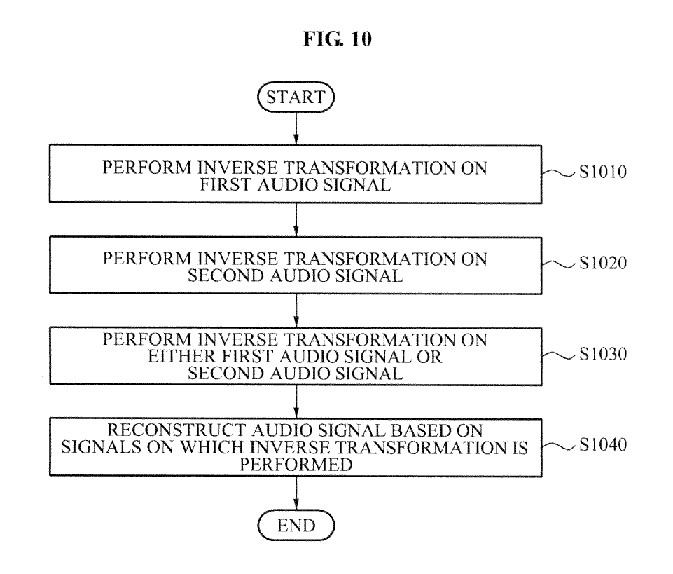

FIG. 10 is a flowchart illustrating a method of decoding an audio signal encoded by switching a time domain transformation scheme and a frequency domain transformation scheme with each other according to exemplary embodiments. The method of decoding the audio signal according to an exemplary embodiment will be herein described in detail with reference to FIG. 10.

In operation S1010, the method may perform a time domain inverse transformation or a frequency domain inverse transformation with respect to the first transformation signal of the first time interval, to which the time domain transformation or the frequency domain transformation having been performed.

In operation S1020, the method may perform the time domain inverse transformation or the frequency domain inverse transformation with respect to the second transformation signal of the second time interval, to which the time domain transformation or the frequency domain transformation having been performed, thereby generating a second inverse transformation signal. The second transformation signal may be transformed by a transformation scheme different from that of the first transformation signal. In operation S1020, the second inverse transformation signal may be generated based on an inverse transformation scheme different from that in operation S1010. In this instance, the second time interval may be a time interval subsequent to the first time interval, and may be adjacent to the first time interval.

In operation S1030, the method may perform the time domain inverse transformation or the frequency domain inverse transformation with respect to the first transformation signal or the second transformation signal based on the inverse transformation scheme in operations S1010 and S1020. Determining the inverse transformation scheme and an object of the inverse transformation based on the inverse transformation schemes in operations S1010 and S1020 is described in detail in FIGS. 2 to 6.

In operation S1040, the method may reconstruct an audio signal of the first time interval based on the first inverse transformation signal and the third inverse transformation signal, or may reconstruct an audio signal of the second time interval based on the second inverse transformation signal and the third inverse transformation signal.

FIG. 11 is a block diagram illustrating a structure of an audio signal encoder 1100 according to exemplary embodiments. An operation of the audio signal encoder 1100 according to an exemplary embodiment will be herein described in detail with reference to FIG. 11. The audio signal encoder 1100 includes a transformation scheme determination unit 1110, a frequency domain transformation unit 1120, a frequency domain coding unit 1130, a time domain transformation unit 1140, a time domain coding unit 1150, a reference signal generation unit 1160, a buffer 1160, and a supplementary transformation unit 1180.

The audio signal encoder 1100 may receive an audio signal corresponding to each time interval in each time interval.

The transformation scheme determining unit 1110 may determine a transformation scheme with respect to the audio signal corresponding to each time interval. According to an exemplary embodiment, when an inputted audio signal has characteristics similar to a sound signal, the transformation scheme determining unit 1110 may determine to perform a frequency domain transformation with respect to the inputted audio signal. According to another exemplary embodiment, when the inputted audio signal has characteristics similar to a voice signal, the transformation scheme determination unit 1110 may determine to perform a time domain transformation with respect to the inputted audio signal.

The transformation unit 1120 may perform a transformation with respect to each audio signal inputted based on the determined result of the transformation scheme determination unit 1110. According to an exemplary embodiment, when the frequency domain transformation is performed with respect to the inputted audio signal, the transformation unit 1120 may perform the frequency domain transformation using an MLT scheme. Based on the MLT scheme, the inputted audio signal may be modulated lapped transformed together with an audio signal of a preceding time interval.

The frequency domain coding unit 1130 may perform an encoding with respect to the audio signal to which the frequency domain transformation having been performed by the transformation unit 1120. According to an exemplary embodiment, the frequency domain coding unit 1130 may perform the encoding with respect to the audio signal to which the frequency domain transformation having been performed based on an AAC scheme used in an MPEG.

When the transformation scheme determination unit 1110 determines to perform the time domain transformation with respect to the inputted audio signal, the transformation unit 1120 may perform the time domain transformation with respect to the inputted audio signal. According to an exemplary embodiment, the transformation unit 1120 may perform a down-sampling with respect to the inputted audio signal to perform the time domain transformation.

The time domain coding unit 1140 may perform a time domain coding with respect to a time-domain transformed audio signal. According to an exemplary embodiment, the time domain coding unit 1140 may perform the time domain coding based on a CELP-based time domain coding scheme such as an AMR, an EVRC, and the like.

The audio signal inputted in the audio signal encoder 1100 may a voice signal and a music sound signal. When a specific audio signal includes both the voice signal and the music sound signal, the audio signal encoder 1100 may perform the time domain transformation with respect to the inputted signal in a specific time interval, and perform the frequency domain transformation with respect to the inputted signal in another time interval.

The transformation scheme determination unit 1110 may determine a transformation scheme with respect to each audio signal inputted in each time interval. According to an exemplary embodiment, even when determining to perform the frequency domain transformation with respect to an audio signal inputted in an (N−1)-th time interval, the transformation scheme determination unit 1110 may determine to perform the time domain transformation with respect to an audio signal of an N-th time interval being consecutive with the (N−1)-th time interval.

Hereinafter, an example in which the frequency domain transformation is performed with respect to the audio signal of the (N−1)-th time interval and an audio signal prior to the (N−1)-th time interval, and the time domain transformation is performed with respect to audio signals starting from the N-th time interval will be described in detail.

When the audio signal of the (N−1)-th time interval is inputted, the transformation scheme determination unit 1110 may determine to perform the frequency domain transformation with respect to the audio signal of the (N−1)-th time interval, and the transformation unit 1120 may perform the frequency domain transformation with respect to an audio signal of an (N−2)-th time interval and the audio signal of the (N−1)-th time interval.

When the audio signal of the N-th time interval is inputted, the transformation scheme determination unit 1110 may determine to perform the time domain transformation with respect to the audio signal of the N-th time interval. The audio signal of the (N−1)-th time interval may not be frequency-domain transformed together with the audio signal of the N-th time interval. Accordingly, the audio signal decoder receiving the encoded audio signal may not perform a frequency domain inverse transformation with respect to the audio signal of the (N−1)-th time interval.

The audio signal encoder 1100 according to an exemplary embodiment may perform the time domain transformation with respect to the audio signal of the (N−1)-th time interval. The audio signal of the (N−1)-th time interval may not be reconstructed by the frequency domain inverse transformation, however, may be reconstructed by the time domain inverse transformation.

The audio signal encoder 1100 may perform the time domain transformation with respect to the audio signal of the (N−1)-th time interval based on the frequency-domain coded signal. The reference signal generation unit 1150 may receive the audio signal of the (N−2)-th time interval to which the frequency domain coding having been performed. The reference signal generation unit 1150 may generate a time domain reference signal of the (N−2)-th time interval based on the signal to which the frequency domain coding having been performed.

The buffer 1160 may store the time domain reference signal of the (N−2)-th time interval generated by the reference signal generation unit 1150. The stored time domain reference signal of the (N−2)-th time interval may be used for transforming the audio signal of the (N−1)-th time interval.

The time domain signal generation unit 1170 may generate a time domain signal with respect to the audio signal of the (N−1)-th time interval.

The time domain coding unit 1140 may perform an encoding with respect to the audio signal of the (N−1)-th time interval.

Since the time domain transformation or the frequency domain transformation may be alternately performed according to characteristics of the inputted audio signal, the audio signal may be encoded to have a high efficiency in a case of performing the encoding with respect to the audio signal using a single codec.

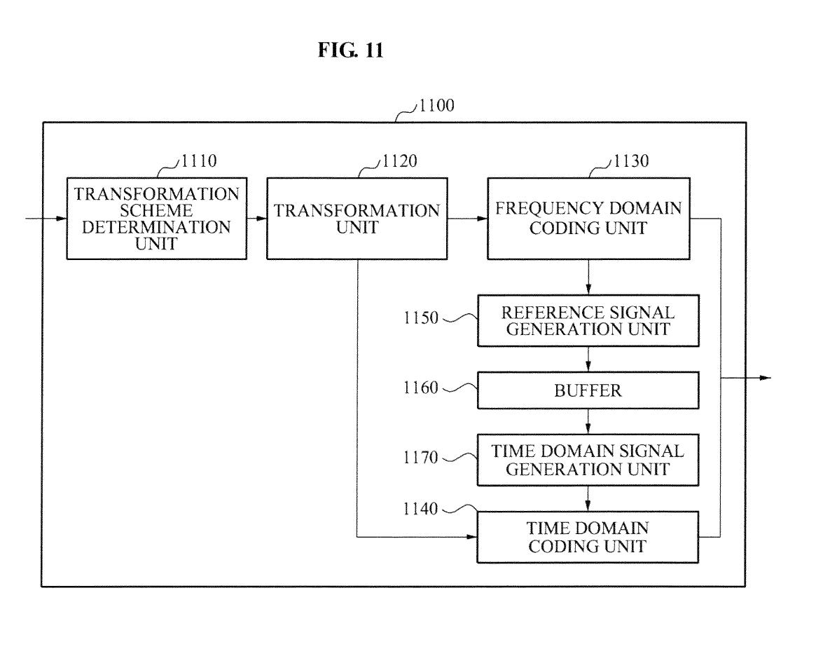

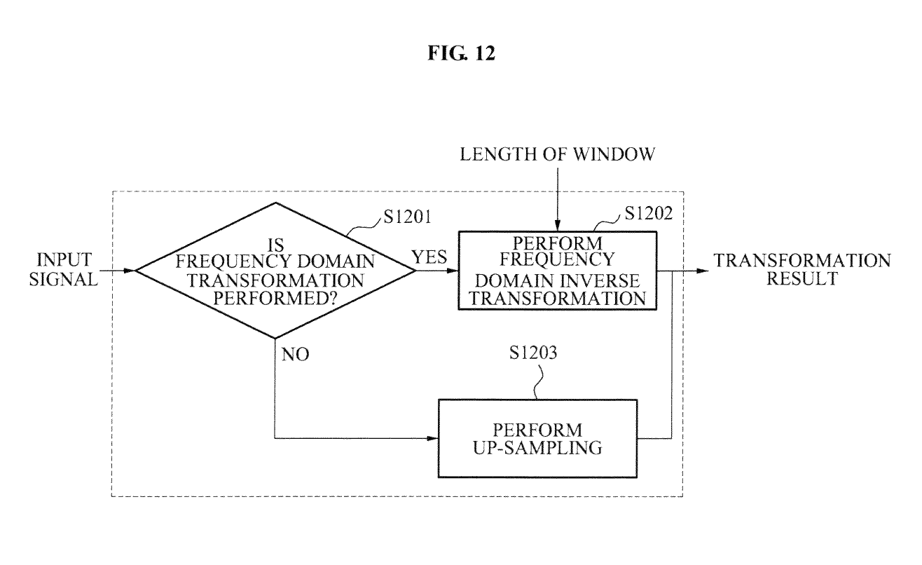

FIG. 12 is a flowchart illustrating an exemplary example of performing either a frequency domain inverse transformation or a time domain inverse transformation with respect to an input signal according to exemplary embodiments. An inverse transformation method according to an exemplary embodiment will be herein described in detail with reference to FIG. 12.

In operation S1201, when a transformed audio signal of an N-th time interval is inputted, whether the transformed audio signal is frequency-domain transformed or time-domain transformed may be determined.

When the transformed audio signal is frequency-domain transformed, a frequency domain inverse transformation may be performed in operation S1202. According to an exemplary embodiment, the frequency domain inverse transformation may be performed with respect to the audio signal of the N-th time interval, to which a frequency domain transformation having been performed, together with an audio signal of an (N−1)-th time interval to which the frequency domain transformation having been performed.

When the transformed audio signal is time-domain transformed, a time domain inverse transformation may be performed in operation S1203. According to an exemplary embodiment, the time domain inverse transformation may be performed by performing a transformation with respect to a sampling late of a transformed audio signal to which an up-sampling having been performed.

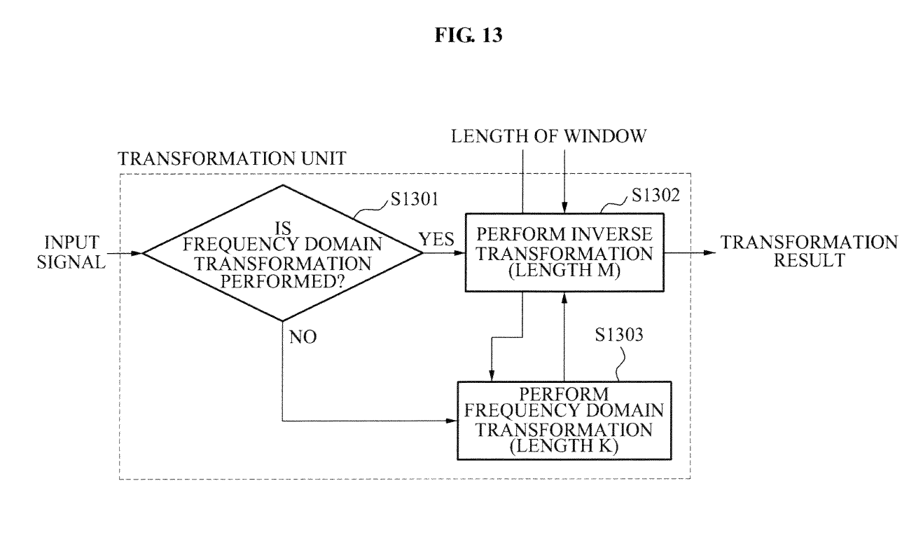

FIG. 13 is a flowchart illustrating another exemplary embodiment of performing either a frequency domain inverse transformation or a time domain inverse transformation with respect to an input signal according to exemplary embodiments. An inverse transformation method according to an exemplary embodiment will be herein described in detail with reference to FIG. 13.

In operation S1301, when a transformed audio signal of an N-th time interval is inputted, whether the transformed audio signal is frequency-domain transformed, or time-domain transformed may be determined.

When the transformed audio signal is frequency-domain transformed, a frequency domain inverse transformation may be performed in operation S1302. According to an exemplary embodiment, the frequency domain inverse transformation performed in operation S1302 may be a frequency domain inverse transformation using M samples.

When the transformed audio signal is time-domain transformed, a frequency domain transformation may be performed with respect to an audio signal to which a time domain transformation is performed in operation S1303. According to an exemplary embodiment, in operation S1303, a frequency domain transformation using K samples may be performed.

In operation S1302, the frequency domain inverse transformation may be performed again with respect to the audio signal to which the frequency domain transformation is performed in operation S1303. The frequency domain inverse transformation performed in operation S1302 may be a frequency domain inverse transformation using M samples. In a case of M>K, the up-sampling may be performed with respect to the audio signal to which the time domain transformation is performed, in operation S1303 and S1302. According to an exemplary embodiment, M and K may be determined based on the sampling rate before and after the transformation.

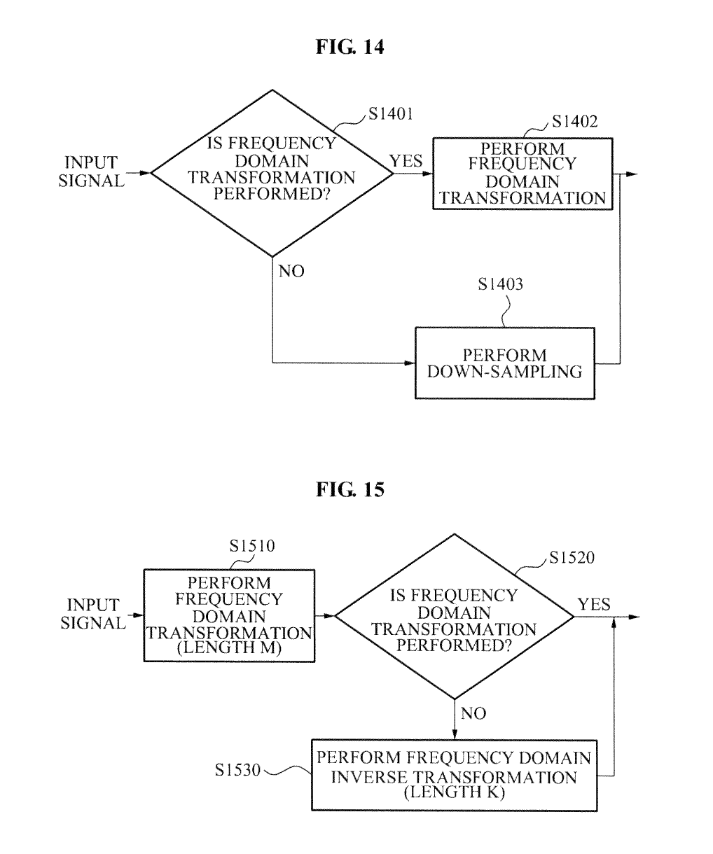

FIG. 14 is a flowchart illustrating an exemplary embodiment of performing either a frequency domain transformation or a time domain transformation with respect to an input signal according to exemplary embodiments. A transformation method according to an exemplary embodiment will be herein described in detail with reference to FIG. 14.

In operation S1401, when an audio signal of an N-th time interval is inputted, whether the inputted audio signal is frequency-domain transformed or time-domain transformed may be determined.

When the inputted audio signal is frequency-domain transformed, a frequency domain transformation may be performed in operation S1402. According to an exemplary embodiment, an MLT may be performed with respect to the audio signal of the N-th time interval together with an audio signal of an (N−1)-th time interval.

When the inputted audio signal is time-domain transformed, a time domain transformation may be performed in operation S1403. According to an exemplary embodiment, a down-sampling may be performed with respect to the audio signal of the N-th time interval to transform a sampling rate, thereby performing the time domain transformation.

FIG. 15 is a flowchart illustrating another exemplary embodiment of performing either a frequency domain transformation or a time domain transformation with respect to an input signal according to exemplary embodiments. A transformation method according to an exemplary embodiment will be herein described in detail with reference to FIG. 15.

In operation S1510, when an audio signal of an N-th time interval is inputted, a frequency domain transformation may be performed with respect to the audio signal. According to an exemplary embodiment, the frequency domain transformation performed in operation S1510 may be a frequency domain transformation using M samples.

In operation S1520, whether the frequency domain transformation or a time domain transformation is performed with respect to the inputted audio signal may be determined. When the frequency domain transformation is performed with respect to the inputted audio signal, an audio signal to which the frequency domain transformation having been transformed in operation S1510 may be outputted.

When the time domain transformation is performed with respect to the inputted audio signal, a frequency domain inverse transformation may be performed with respect to an input audio signal to which the frequency domain transformation having been performed. According to an exemplary embodiment, the frequency domain inverse transformation performed in operation S1530 may be a frequency domain inverse transformation using K samples.

When the time domain transformation is performed with respect to the inputted audio signal, the frequency domain transformation may be performed using M samples, and the frequency domain inverse transformation may be performed using K samples. In a case of M>K, a sampling rate of the inputted audio signal may be reduced.

Exemplary embodiments of the present invention may be applicable in a Moving Picture Experts Group (MPEG) Unified Speech and Audio Coding (USAC) as follows.

The above described frequency domain coding may be performed in a frequency domain coding scheme in the MPEG USAC, and may use a method of transforming an input signal into a frequency axis through the MDCT. Also, in a USAC specification, the frequency domain coding may designate information corresponding to ‘fd_channel_stream( )’.

According to another exemplary embodiment, a case of encoding/decoding linear prediction (LP) residual signals in an MDCT-domain as in a weighted LP transform (wLPT) of USAC may be adopted. A wLPT decoding tool may be used to turn the LP residual signals from the MDCT-domain back into a time domain signal, and to output the time domain signal including a weighted LP synthesis filtering.

The above described time domain coding may use an algebraic code excited linear prediction (ACELP) in the MPEG USAC. An ACELP tool may provide a way to efficiently represent a time domain excitation signal by combining a long term predictor (adaptive codeword) with a pulse-like sequence (innovation codeword).

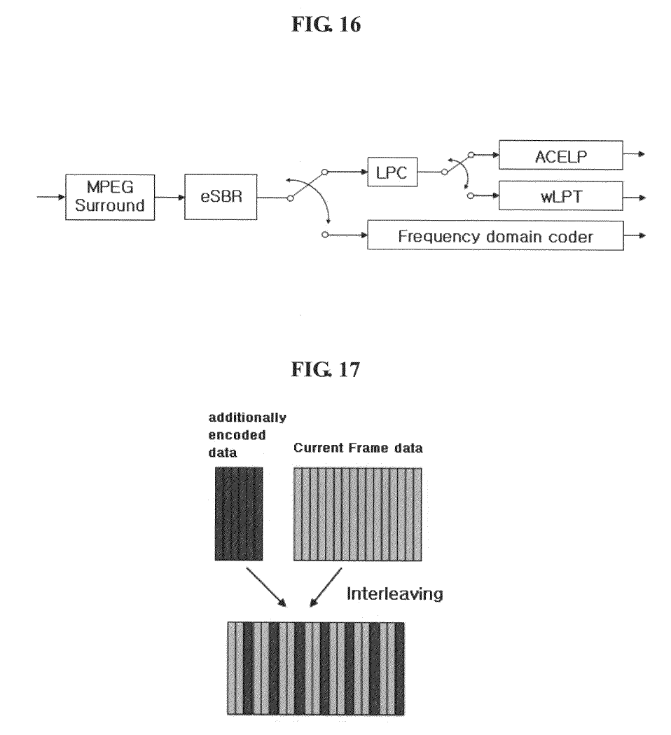

As illustrated in FIG. 16, a switching in an encoding of a frequency axis and a time axis in an USAC codec may be generated in a switching of a frequency domain coder and the ACELP and a switching of the wLPT and the ACELP.

An MPEG surround illustrated in FIG. 16 may be a technology for encoding a multi-channel signal or a stereo signal. The MPEG surround may use a compact parametric representation of the human's auditory cues for spatial perception to allow for a bit-rate efficient representation of the multi-channel signal.

An enhanced Spectral Band Replication (eSBR) illustrated in FIG. 16 may be a module of performing a parametric coding a high frequency signal using a less information amount through a low frequency signal and additional information.

An eSBR tool may regenerate a high-band of the audio signal. The eSBR tool may be based on replication of the sequences of harmonics, and may be truncated during encoding. The eSBR tool may adjust a spectral envelope of the generated high-band, apply an inverse filtering, and add noise and sinusoidal components in order to recreate the spectral characteristics of the original signal.

A Linear Prediction Coefficient (LPC) illustrated in FIG. 16 may be defined as follows.

A function of an LPC tool decoder may consist of decoding the transmitted parameters and performing synthesis to obtain the reconstructed signal. In the ACELP mode, the transmitted parameters may consist of LP parameters, adaptive and fixed-codebook indices, and adaptive and fixed-codebook gains. In a transform coded excitation (TCX) mode, the transmitted parameters may consist of LP parameters, energy parameters, and quantization indices of MDCT coefficients.

As an example of a specific encoding method of overcoding, a method of interleaving a frequency signal of an overlapped interval and a frequency signal of a current frame when performing the overcoding on the frequency axis may be given. FIG. 17 shows an exemplary embodiment of interleaving the two signals.

In this instance, a quantization method and a lossless encoding method may be shared with respect to data of the current frame and data to which the overcoding is performed. A quantization and a lossless encoding may be performed with respect to the interleaved data. A decoding process may be an inverse process of the above described encoding process.

The above described methods may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

As described above, according to exemplary embodiments, the method of detecting an object using the combination detector may overcome limitations of a conventional single detector, and actively select a detector being suitable for each layer, thereby ensuring a detection effect, and improving an operation speed.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An audio signal coding apparatus, comprising:
a first transformation unit to perform any one transformation of a time domain transformation and a frequency domain transformation with respect to a first audio signal of a first time interval to generate a first transformation signal;
a second transformation unit to perform the other transformation with respect to a second audio signal of a second time interval subsequent to the first time interval, the second time interval being adjacent to the first time interval, to generate a second transformation signal, the other transformation being different from the transformation performed by the first transformation unit; and
a third transformation unit to perform any one transformation of the time domain transformation and the frequency domain transformation with respect to either the first audio signal or the second audio signal based on respective transformations of the first transformation unit and the second transformation unit to generate a third transformation signal, wherein
the first audio signal is reconstructed based on the first transformation signal and the third transformation signal, or the second audio signal is reconstructed based on the second transformation signal and the third transformation signal.

2. The audio signal coding apparatus of claim 1, further comprising:
a transformation scheme determination unit to determine a transformation scheme performed by the respective transformation units, wherein
the respective transformation units perform the transformation with respect to the respective audio signals based on the determined transformation scheme.

3. The audio signal coding apparatus of claim 1, wherein the first transformation unit performs the frequency domain transformation with respect to the first audio signal and a third audio signal of a third time interval prior to the first time interval, the third time interval being adjacent to the first time interval, the audio signal coding apparatus further comprising:
a fourth transformation unit to perform the frequency domain transformation with respect to the third audio signal and a fourth audio signal of a fourth time interval prior to the third time interval, the fourth time interval being adjacent to the third time interval, to generate a fourth transformation signal;
a reference signal generation unit to generate a time domain reference signal based on the fourth transformation signal and the first transformation signal; and
a signal prediction unit to generate a predictive signal with respect to the first audio signal based on the time domain reference signal, wherein
the third transformation unit performs the transformation on a difference between the first audio signal and the predictive signal to perform the time domain transformation.

4. The audio signal coding apparatus of claim 1, wherein the first transformation unit performs the frequency domain transformation with respect to the first audio signal, and the third transformation unit performs the time domain transformation according to at least one of an Adaptive Differential Pulse Code Modulation (ADPCM) coding scheme, a Mu-Law coding scheme, and an A-law coding scheme.

5. The audio signal coding apparatus of claim 1, wherein a length of the first time interval is less than that of the second time interval when the third transformation unit performs the transformation on the first audio signal, and a length of the second time interval is less than that of the first time interval when the third transformation unit performs the transformation on the second audio signal.

6. The audio signal coding apparatus of claim 1, further comprising:
a time interval division unit to divide the first time interval into a first time domain and a second time domain, wherein
the first transformation unit performs the transformation excluding the first audio signal of the second time domain, and the third transformation unit performs the transformation, being different from the transformation of the first transformation unit, excluding the first audio signal of the first time domain.

7. The audio signal coding apparatus of claim 6, wherein the time interval division unit divides the audio signal of the first time domain and the audio signal of the second time domain using a rectangular time window.

8. The audio signal coding apparatus of claim 1, wherein the respective transformation units perform the frequency domain transformation using a Modulated Lapped Transformation (MLT) scheme.

9. The audio signal coding apparatus of claim 1, wherein the respective transformation units perform a down-sampling on the respective transformation signals to perform the time domain transformation.

10. The audio signal coding apparatus of claim 1, wherein the respective transformation units perform a Frequency Varying Modulated Lapped Transformation (FV-MLT) to perform the time domain transformation.

11. An audio signal decoding apparatus, comprising:
a first inverse transformation unit to perform any one inverse transformation of a time domain inverse transformation and a frequency domain inverse transformation with respect to a first transformation signal of a first time interval on which a time domain transformation or a frequency domain transformation is performed;
a second inverse transformation unit to perform the other inverse transformation with respect to a second transformation signal of a second time interval subsequent to the first time interval, the second time interval being adjacent to the first time interval, to generate a second inverse transformation signal, the other inverse transformation being different from the inverse transformation performed by the first inverse transformation;
a third inverse transformation unit to perform any one of the time domain inverse transformation and the frequency domain inverse transformation, with respect to either the first transformation signal or the second transformation signal based on respective inverse transformation schemes of the first inverse transformation unit and the second inverse transformation unit, to generate a third inverse transformation signal; and
a signal restoration unit to reconstruct an audio signal of the first time interval based on the first inverse transformation signal and the third inverse transformation signal, or to reconstruct an audio signal of the second time interval based on the second inverse transformation signal and the third inverse transformation signal.

12. The audio signal decoding apparatus of claim 11, further comprising:
a transformation mode determining unit to determine which of the time domain transformation and the frequency domain transformation is performed with respect to the transformation signal of the respective time intervals, wherein
the respective inverse transformation units perform the inverse transformation with respect to the respective transformation signals based on the determined result.

13. The audio signal decoding apparatus of claim 11, wherein the first inverse transformation unit performs the frequency domain inverse transformation based on a third transformation signal being obtained by performing the frequency domain transformation of a third time interval prior to the first time interval, the third time interval being adjacent to the first time interval, the audio signal decoding apparatus further comprising:
a fourth inverse transformation unit to perform the frequency domain inverse transformation based on the third transformation signal and a fourth transformation signal to generate a fourth inverse transformation signal, the fourth transformation signal being obtained by performing the frequency domain transformation of a fourth time interval prior to the third time interval, the fourth time interval being adjacent to the third time interval;
a reference signal generation unit to generate a time domain reference signal corresponding to an audio signal of the third time interval based on the fourth inverse transformation signal and the first inverse transformation signal; and
a signal prediction unit to generate a predictive signal with respect to the audio signal of the first time interval based on the time domain reference signal, wherein
the signal reconstruction unit reconstructs the predictive signal with respect to the audio signal of the first time interval based on the time domain reference signal.

14. The audio signal decoding apparatus of claim 11, wherein a length of the first time interval is less than that of the second time interval when the third inverse transformation unit performs the inverse-transformation with respect to the first audio signal, and a length of the second time interval is less than that of the first time interval when the third inverse transformation performs the inverse-transformation with respect to the second audio signal.

15. The audio signal decoding apparatus of claim 11, further comprising:
a time interval division unit to divide the first time interval into a first time domain and a second time domain, wherein
the first inverse transformation unit performs the inverse transformation excluding the first audio signal of the second time domain, and the third inverse transformation unit performs the inverse transformation, being different from the inverse transformation performed by the first inverse transformation unit, excluding the first audio signal of the first time domain.

16. The audio signal decoding apparatus of claim 15, wherein the time interval division unit divides, using a rectangular time window, the first audio signal of the first time domain and the first audio signal of the second time domain.

17. The audio signal decoding apparatus of claim 11, wherein the respective inverse transformation units perform the frequency domain inverse transformation using an FV-MLT scheme.

18. The audio signal decoding apparatus of claim 11, wherein the respective inverse transformation units perform an up-sampling with respect to the respective transformation signals to perform the time domain inverse transformation.

19. The audio signal decoding apparatus of claim 11, wherein the respective inverse transformation units perform an FV-MLT to perform the time domain inverse transformation.

20. An audio signal coding method, comprising:
performing any one transformation of a time domain transformation and a frequency domain transformation with respect to a first audio signal of a first time interval to generate a first transformation signal;
performing the other transformation with respect to a second audio signal of a second time interval subsequent to the first time interval, the second time interval being adjacent to the first time interval, to generate a second transformation signal, the other transformation being different from the transformation performed with respect to the first audio signal; and
performing any one transformation of the time domain transformation and the frequency domain transformation, with respect to either the first audio signal or the second audio signal based on respective transformation schemes of the performing of the any one transformation and the performing of the other transformation, to generate a third transformation signal,
wherein the first audio signal is reconstructed based on the first transformation signal and the third transformation signal, and the second audio signal is reconstructed based on the second transformation signal and the third transformation signal.

21. An audio signal decoding method, comprising:
performing any one inverse transformation of a time domain inverse transformation and a frequency domain inverse transformation, with respect to a first transformation signal of a first time interval on which either a time domain transformation or a frequency domain transformation is performed, to generate a first inverse transformation signal;
performing the other inverse transformation with respect to a second transformation signal of a second time interval subsequent to the first time interval, the second time interval being adjacent to the first time interval, to generate a second inverse transformation signal, the other inverse transformation being different from the inverse transformation performed with respect to the first transformation signal;
performing any one inverse transformation of the time domain inverse transformation and the frequency domain inverse transformation, with respect to either the first transformation signal or the second transformation signal based on respective inverse transformation schemes of the performing of the any one inverse transformation and the performing of the other inverse transformation, to generate a third inverse transformation signal; and
reconstructing an audio signal of the first time interval based on the first inverse transformation signal and the third inverse transformation signal, or reconstructing an audio signal of the first time interval or the second time interval based on the second inverse transformation signal and the third inverse transformation signal.

22. At least one medium comprising computer readable instructions implementing the method of claim 20.

23. At least one medium comprising computer readable instructions implementing the method of claim 21.
